(19) United States
(12) Patent Application Publication
(10) Pub. No.: US 2026/0213969 A1
(43) Pub. Date: Jul. 23, 2026

(54) OPTIMIZING CONTROLLER DRIVEN MULTICAST FOR SCALABILITY

(71) Applicant: Cisco Technology, Inc., San Jose, CA (US)

(72) Inventors: Mankamana Prasad MISHRA, San Jose, CA (US); Sridhar SANTHANAM, Dublin, CA (US); Rishabh N PAREKH, San Jose, CA (US)

(21) Appl. No.: 19/033,659

(22) Filed: Jan. 22, 2025

(51) Int. Cl. H04L 12/18; H04L 45/036; H04L 45/16

(52) U.S. Cl. CPC H04L 12/1868; H04L 45/036; H04L 45/16

(57) ABSTRACT

In one embodiment, a method for controller driven multicast for scalability includes analyzing, by a controller, a plurality of network nodes to determine replication characteristics associated with the plurality of network nodes and identifying, by the controller, a first subset of the plurality of network nodes that are candidates for network node replication. The method can further include identifying, by the controller, a second subset of the plurality of network nodes that are not candidates for network node replication, and initiating, by the controller, one or more path computation element protocol sessions based, at least in part, on identification of the first subset of the plurality of network nodes and the second subset of the plurality of network nodes.

### TECHNICAL FIELD

The present disclosure relates generally to computer networks, and, more particularly, to controller driven multicast for scalability.

### BACKGROUND

Various types of networks can employ a controller-based multicast paradigm to facilitate communication between nodes in the network. Some examples of networks that can benefit from the controller-based multicast paradigm include networks that provide media streaming, business multicast virtual private networks (VPNs), networks that provide financial data delivery, and networks that are used for surveillance, to name a few.

In general, the network edge devices are provisioned by enabling controller-driven multicast and a Path Computation Element Protocol (PCEP) connection is initiated to each of the devices in the network. At this stage, through Border Gateway Protocol (BGP)-based overlay signaling or static configuration, ingress provider edge (PE) devices can be made aware of the list of receivers in the network and can be provided with information the multicast flow in the network. These devices can then send requests using PCEP to the controller. Based on this information, the controller can generally calculate a tree and begin the process of programming replication nodes.

However, as the number of devices/nodes in the network increases, a scale limitation may be experienced as the number of PCEP (e.g., transmission control protocol (TCP) based) connections that can be made in the network per controller reaches unsustainable levels. In particular, it is common to create PCEP connections with all the devices in the network deployment, and certain networks today already have millions of devices under their control, and this number is increasing.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example configuration for a network tree;

FIG. 4 illustrates an example of provisioning edge devices in a network;

FIG. 5 illustrates an example programming replication nodes in a network;

FIG. 6 illustrates an example topology in accordance with the disclosure; and

FIG. 7 illustrates an example procedure for controller driven multicast for scalability.

### DESCRIPTION OF EXAMPLE EMBODIMENTS

### Overview

According to one or more embodiments of the disclosure, a method for controller driven multicast for scalability can include analyzing, by a controller, a plurality of network nodes to determine replication characteristics associated with the plurality of network nodes and identifying, by the controller, a first subset of the plurality of network nodes that are candidates for network node replication. The method can further include identifying, by the controller, a second subset of the plurality of network nodes that are not candidates for network node replication, and initiating, by the controller, one or more path computation element protocol sessions based, at least in part, on identification of the first subset of the plurality of network nodes and the second subset of the plurality of network nodes.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

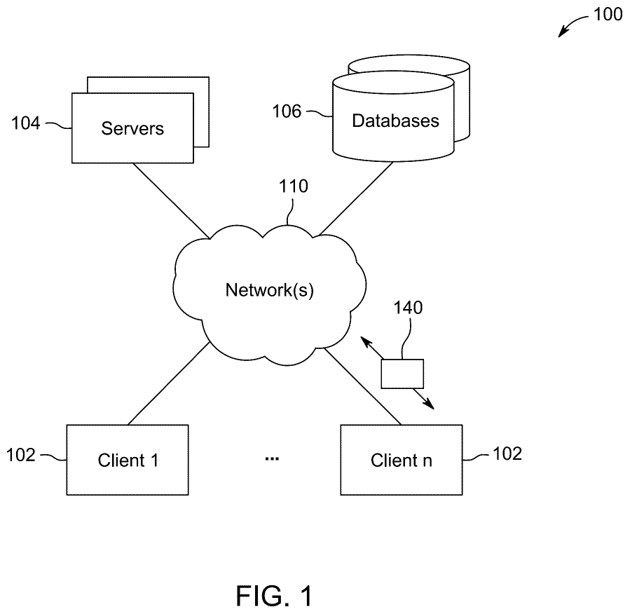

FIG. 1 is a schematic block diagram of an example simplified computing system (e.g., computing system 100) illustratively comprising any number of client devices (e.g., client devices 102, such as a first through N^{th} client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

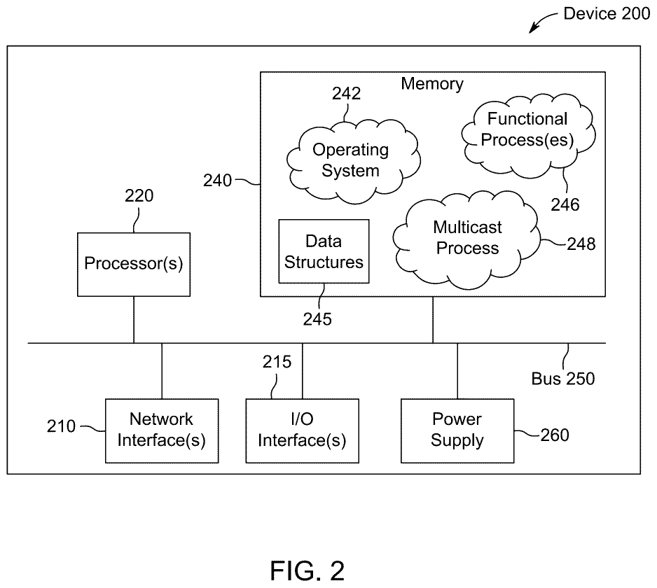

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a multicast process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

For instance, one or more functional processes 246 may include computer executable instructions executed by the processor(s) 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, the one or more functional processes 246 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, one or more functional processes 246 and/or multicast process (process 248) may include computer executable instructions that, when executed by processor(s) 220, cause device 200 to perform the techniques described herein. To do so, in some implementations, one or more functional processes 246 and/or process 248 may utilize machine learning.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Controller Driven Multicast for Scalability

As noted above, as the number of devices and, hence, the number of nodes in the network increases, a scale limitation may be experienced where the number of PCEP (e.g., transmission control protocol (TCP) based) connections can be made in the network per controller. In many deployments, the total number of devices in the network can be on the order of hundreds of thousands, or even millions. As there is currently no consideration for which node may potentially participate in replication and which would not, prior approaches generally end up creating PCEP connection with all the devices.

However, this can lead to deployment challenges for customers and/or network administrators because such approaches require an immense number of controllers and/or controller resources to handle the large number of devices and can require a large amount of processing overhead of PCEP connection with all nodes in network, among other challenges.

The techniques herein, therefore, provide a framework where the controller can make PCEP connections and/or (permanent) TCP connections only using limited number of devices in network. This can allow for improved controller-driven multicast deployment scaling, as discussed in more detail below.

Specifically, according to one or more embodiments of the disclosure as described in detail below, a method for controller driven multicast for scalability can include analyzing, by a controller, a plurality of network nodes to determine replication characteristics associated with the plurality of network nodes and identifying, by the controller, a first subset of the plurality of network nodes that are candidates for network node replication. The method can further include identifying, by the controller, a second subset of the plurality of network nodes that are not candidates for network node replication, and initiating, by the controller, one or more path computation element protocol sessions based, at least in part, on identification of the first subset of the plurality of network nodes and the second subset of the plurality of network nodes.

As further described below, a controller (e.g., software defined networking (SDN) controller) may facilitate the integration between a multicasting virtual private network (VPN) and an edge replicated multicast network. For example, the SDN controller may select one or more multicast nodes from virtual routers specified in the multicast replication tree. The SDN controller may send information identifying the multicast node to a provider edge (PE) device for the source VPN such that the PE device may use the information to steer multicast traffic from the source VPN site across the Layer 3 VPN network to the multicast bridge node of the receiver VPN site. The SDN controller may also send the information, e.g., a corresponding label for the selected multicast node and selected multicast bridge node's Internet Protocol (IP) address, to a remote multicast sender to stitch the MVPN and ERMVPN.

When the multicast node receives the multicast traffic with the multicast bridge node label, the multicast bridge node determines from the information that it is the multicast traffic is coming from outside the data center and that the multicast node is configured to receive the multicast traffic. The multicast node may also determine from the information to send the multicast traffic to local-receivers (e.g., virtual machines/containers) and to a parent node of the multicast node indicated from the edge replicated multicast tree.

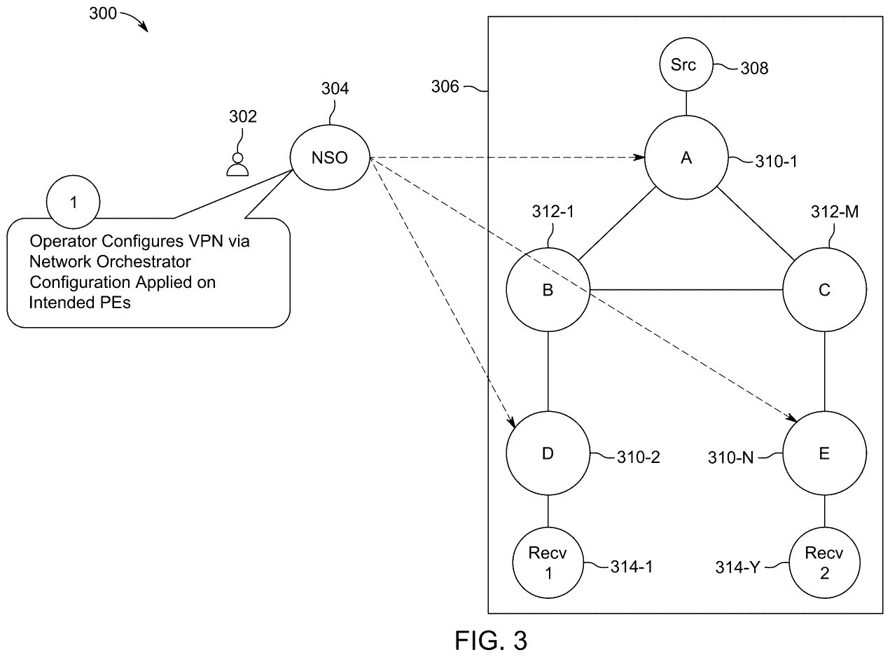

FIG. 3 illustrates an example configuration for a simplified virtual private network tree. FIG. 3 shows a system 300 that includes a Network Services Orchestrator (i.e., NSO 304) that can be accessed by a network operator 302 (e.g., a network administrator, user, etc.). At Step (1), the network operator 302 can configure VPN settings via the NSO 304 to be applied to a first subset of PEs defined by a network tree 306. This subset of PEs, or “intended PEs,” can be referred to as “nodes” in the network tree 306, and can include a first node 310-1, a second node 310-2, through an N^{th} node 310-N (intended PE nodes 310), i.e., Node A, Node D, and Node E. In some implementations, the intended PE nodes 310 can be selected by the network operator 302 for configuration of various VPN settings associated with the intended PE nodes 310.

As shown in FIG. 3, there are other PEs that are not “intended PEs.” For example, the network operator 302 may decline or decide not to configure VPN settings via the NSO 304 for a second subset of PEs defined by a network tree 306. This subset of PEs, or “non-configured PEs,” can also be referred to as “nodes” in the network tree 306, and can include a first node 312-1 through an M^{th} node 312-M (collectively referred to herein as non-configured PE nodes 312), i.e., Node B and Node C.

In accordance with the disclosure, the non-configured PE nodes 312 do not need to be programmed and, instead, only the intended PE nodes 310 may be programmed. As will be understood, this can drastically reduce the time and resources needed to configure the network tree 306 and, hence, nodes in the network, because only a fraction of the PE nodes are programmed.

In some implementations, the network tree 306 can include a source node 308 from which the other nodes (e.g., the intended PE nodes 310 and the non-configured PE nodes 312) originate. Further, as will be appreciated, the network tree 306 can terminate at one or more receiver nodes (e.g., a first receiver node 314-1 through a Y^{th} receiver node 314-Y).

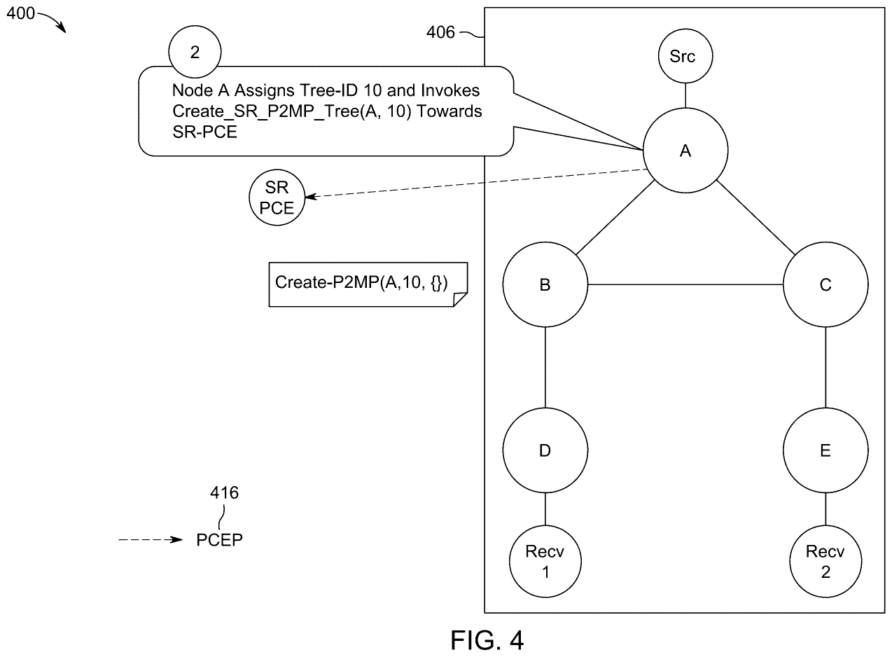

FIG. 4 illustrates an example of provisioning edge devices in a network. FIG. 4 shows a system 400, which can be analogous to the system 300 of FIG. 3. A message 416 can be provided in the Path Computation Element Protocol (PCEP), which is a TCP-based protocol used for communication between a “Path Computation Client” (PCC) and a “Path Computation Element” (PCE), allowing the PCC to request path calculations for traffic routing across a network.

The network tree 406 of FIG. 4 can be analogous to the network tree 306 of FIG. 3. Similarly, the source node, network nodes (Node A, Node B, Node C, Node D, and Node E), and the receiver nodes can be analogous to similarly referenced elements in FIG. 3.

As shown in FIG. 4, at Step (2), the first intended PE node (e.g., the first node 310-1) can assign a tree identification tag and invoke an operation using a Segment Routing Path Computation Element (SR-PCE). As will be understood, SR-PCE provides stateful PCE functionality by extending the existing IOS-XR PCEP functionality with additional capabilities.

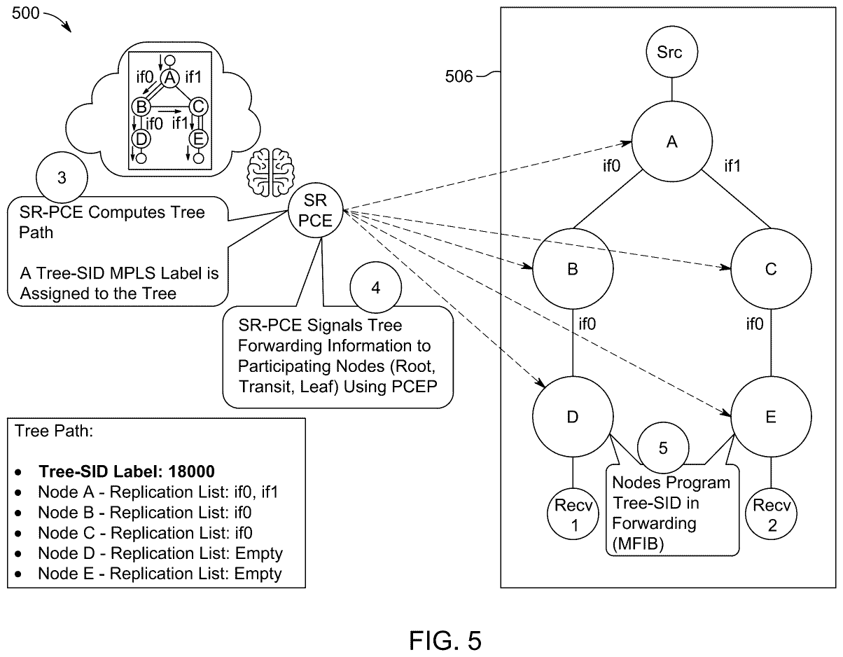

FIG. 5 illustrates an example programming replication nodes in a network. FIG. 5 shows a system 500, which can be analogous to the system 300 of FIG. 3 and/or the system 400 of FIG. 4. It is noted that several steps related to border gateway (BGP) signaling have been omitted between FIG. 4 and FIG. 5. These omitted steps are understood in the art are omitted so as to not obfuscate the disclosure. In FIG. 5, the controller has calculated the network tree 506 (which may be analogous to the network tree 306 of FIG. 3 and/or the network tree 406 of FIG. 4), and the replication nodes may be programmed.

For example, at Step (3), SR-PCE is utilized to compute paths in the network tree 506. Next, at Step (4), SR-PCE signals tree forwarding information to participating network nodes. Next, at Step (5), the nodes program tree segment identifier (Tree-SID) using a Multicast Forwarding Information Base (MFIB) architecture. Tree-SID is a blend of two words: tree and SID. The tree word refers to the multicast tree while the SID word refers to Segment IDentifier, which corresponds to Segment Routing (SR). Accordingly, Tree-SID is a solution for multicast on a Segment Routing network. In some implementations, Tree-SID is an SDN controller-based approach to building a point-to-multipoint (P2MP) trees in a SR domain.

With the central knowledge of the network at the SR-PCE, the tree can be built using various constraints. In general, the role of the controller or the PCE is to compute the tree and program the data plane. The forwarding information then needs to be pushed to the routers which are part of the specific tree. In order to computes paths, the controller may be able to access the topology information of the network. In some implementations, this topology information may be obtained by running the same IGP as the routers and/or by running BGP LS. In some implementations, the controller may have a few redundant connections for both the IGP and the BGP-LS sessions.

In summary, the SR-PCE can be responsible for:
1. Learning the topology. A common mechanism for learning the topology is using BGP Link State (LS). Through BGP-LS, the controller sucks up the Link State database. Through the LS database, the controller can use any sort of algorithm (like Dijkstra) to calculate paths.
2. Learning the Root and Leaf's of the Tree. SR-PCE also needs to know the Tree Root and Endpoints. This can be defined by an operator or dynamically through a protocol, like BGP Auto Discovery (AD).
3. Computing the Tree. With the central knowledge at the controller, the tree can be computed according to different metrics and constraints. Non-limiting metrics and/or constraints can include: optimization objective (metric); IGP/TE/Delay; affinity constraints; etc.
4. Knowing the MPLS Labels it can use. The allocation and programming of the label for each Tree-SID can be done by the SR-PCE. For example, the entire tree can be seen as a segment.
   1. All the routers in the network can be allocated the same label range for Tree-SID.
   2. The controller can assign the same label for a tree on all the routers, thereby making the label known and predictable and making it easier to manage and troubleshoot the network.
   3. In some implementations, the label range from the SR Local Block (SRLB), although implementations are not so limited.
5. Having a mechanism to program the Forwarding state. SR-PCE needs to program forwarding state on all the routers in the path of the tree. In some implementations, this is done via PCEP.

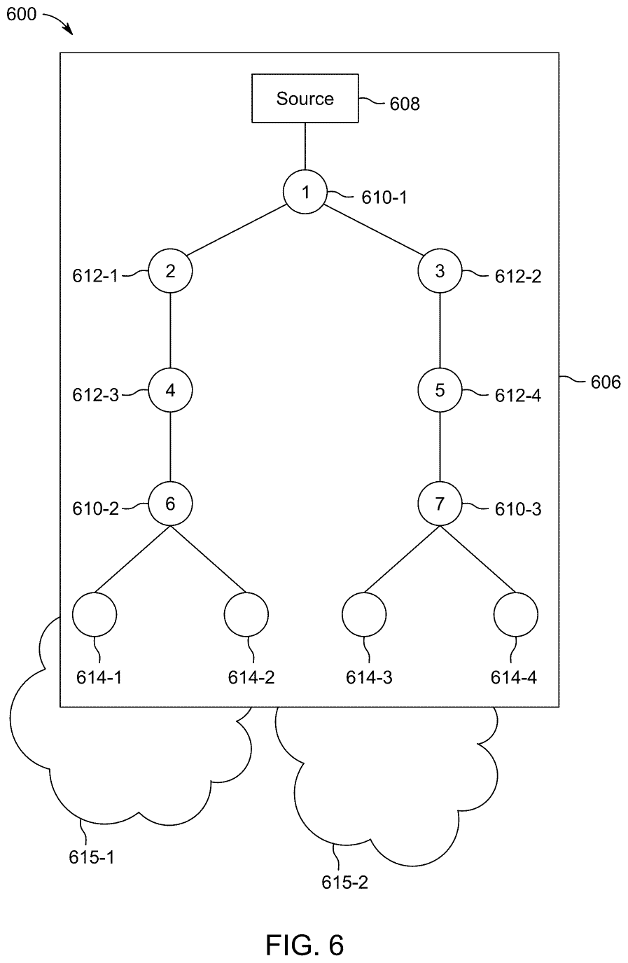

Operationally, FIG. 6 illustrates an example topology in accordance with the disclosure. As shown in FIG. 6, the topology may be part of a system 600 and is indicated by a network tree 606, which can be analogous to the network tree 306, the network tree 406, and/or the network tree 506 of FIG. 3, FIG. 4, and/or FIG. 5. Similarly, the nodes (e.g., Node 1, Node 2, Node 3, Node 4, Node 5, Node 6, and/or Node 7, etc.) can be analogous to the network nodes (e.g., Node A, Node B, Node C, Node D, Node E, etc.) discussed above. Further, some of the network nodes shown in FIG. 6 can be network nodes that are candidates for replication (e.g., Node 1 610-1, Node 6 610-2, and/or Node 7 610-3), while other network nodes may not be candidates for replication (e.g., Node 2 612-2, Node 3 612-2, Node 4 612-3, and/or Node 5 610-4). The manner in which each network node is identified as a candidate or not a candidate for replication is described in detail below. As shown in FIG. 6, the network tree 606 further includes a plurality of receiver nodes (e.g., a first receiver node 614-1, a second receiver node 614-2, a third receiver node 614-3, and a fourth receiver node 614-4, etc.). The receiver nodes may be coupled to one or more networks, such as a first network 615-1 and/or a second network 615-2.

In general, and as described in more detail herein, implementations of the disclosure include: identifying nodes that cannot be replicator nodes (e.g., Node 2 612-2, Node 3 612-2, Node 4 612-3, and/or Node 5 612-4); identifying nodes that can be replicator nodes (e.g., Node 1 610-1, Node 6 610-2, and/or Node 7 610-3); and initiating a PCEP session to those nodes that can be replicator nodes (either proactively and/or automatically, or in on-demand in response to command or other triggering event).

In some implementations, the controller (e.g., SDN controller, SR-PCE, etc.) can execute a background algorithm to identify which nodes cannot be replicator nodes. The controller then marks these nodes (i.e., the nodes that cannot be replicator nodes) to ensure that a PCEP connection is not made involving these nodes. In some implementations, the controller may also mark the nodes that cannot be replicator nodes to ensure that a permanent TCP connection is not formed utilizing these nodes. In addition, the controller may mark the nodes that can be replicator nodes in preparation for forming a PCEP (or other suitable) connection utilizing these nodes.

As mentioned above, subsequent to determining which nodes can be replicator nodes and which nodes cannot be replicator nodes, the PCEP session may be initiated either proactively or on-demand. For the case in which the PCEP session is created proactively, the PCEP connections may be continuously turned on (e.g., enabled) and the PCEP session may be initiated with all the nodes (e.g., routers, edge devices, etc.) that are going to participate as replicator nodes. In the case in which the PCEP session is initiated on demand, the PCEP session may only be initiated when the multicast tree is being calculated and at least one node is participating in replication.

In some implementations, the algorithm that the controller utilizes to identify which nodes are candidates to be replicator nodes and which nodes are not candidates to be replicator nodes can seek to examine “next hop” information from any node in the system 600. As one example, a particular node may not be determined to be a candidate for replication (and therefore would not be determined to be a replicator node) if there are only two nodes connected to that particular node. That is, such transit nodes (nodes of a tree with no “branches” or choices onto which traffic may be sent) merely offer a passthrough connection between two ports, taking inbound traffic received on one port and passing it through as outbound traffic on its other connected port. This determination may be made based on currently connected nodes and/or device configuration settings and may be made by looking at the entire network graph proactively (i.e., which nodes physically could be a replicator based on connectivity) or on-demand based on programming (i.e., which nodes are actually determined to be configured as a multicast replicator for multicast trees).

As another example, the controller may execute an algorithm to determine (via a “dry run” or other suitable execution of the algorithm(s)) each ingress device in the network to identify which nodes in the network may not be candidates to be replicator nodes.

In any event, once the nodes that are candidates for replication and the nodes that are not candidates for replication, the controller may then initiate a PCEP session for only the replicator nodes, either on demand or proactively, as discussed above. (Note that while PCEP sessions may still be established with non-replicator nodes, it is understood herein that such connections are generally unnecessary under current protocol operation.) According to the techniques herein, should the candidacy of any node change, such as by becoming a candidate for replication (e.g., when a third additional node is connected to the device in question), or by no longer being a candidate for replication (e.g., one or more nodes are disconnected from the device in question, leaving only two nodes being connected to the device), then the PCEP session establishment may also change to match such updated information.

Depending on the implementation, the techniques described herein offer various benefits when compared to current approaches. For example, in the case where the number of nodes, and therefore the number of routers or other devices in the network, are in the thousands or hundreds of thousands or even more, scalability can be enhanced herein as the number of controllers and/or controller resources can be greatly reduced in comparison to some approaches. For instance, in an example network of over a million nodes, it is not unlikely for only a few thousand of those nodes to be candidates for replication. In condition, in such implementations, debugging and/or control of packet flows in the network may be vastly simplified in comparison to some approaches.

Further, implementations described herein contemplate scenarios in which the network topology changes over time. For example, during proactive and/or on demand initiation of the PCEP sessions disclosed herein, the controller can re-analyze the nodes in the network to determine if any nodes have changed their status as being nodes that are candidates for replication vs. nodes that are not candidates for replications. Stated alternatively, at any stage during proactive and/or on demand initiation of PCEP session(s), the controller may determine that a node that previously a candidate for replication has become a node that is not a candidate for replication, or vice versa. In such scenarios, the controller may then mark such nodes accordingly and initiate (or re-initiate) the PCEP session in light of such changes or variances in the network.

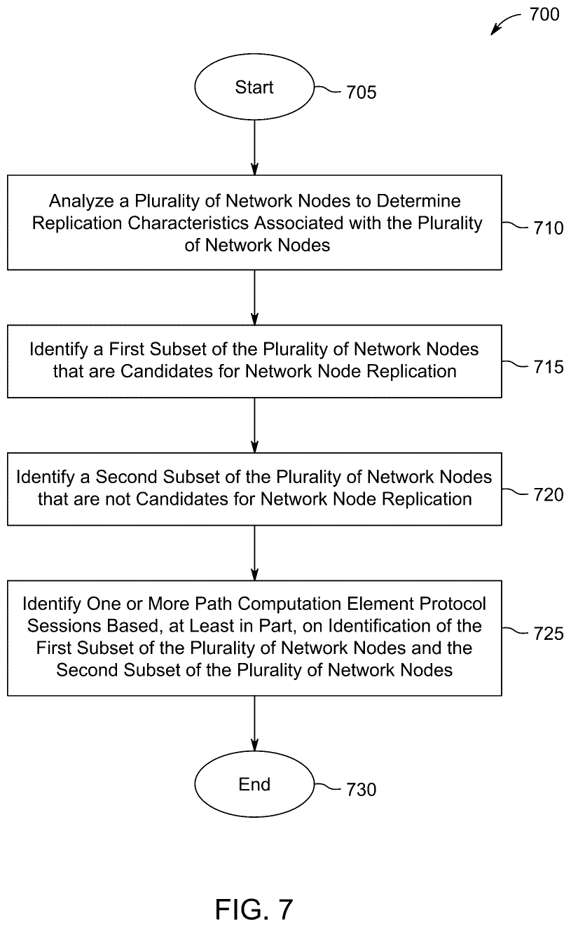

In closing, FIG. 7 illustrates an example simplified procedure for controller driven multicast for scalability in accordance with one or more embodiments described herein, particularly from the perspective of a device, such as a controller. For example, a non-generic, specifically configured device (e.g., device 200, an apparatus, such as a controller, PCE, etc.) may perform procedure 700 by executing stored instructions (e.g., process 248). The procedure 700 may start at step 705, and continues to step 710, where, as described in greater detail above, a controller analyzes a plurality of network nodes to determine replication characteristics associated with the plurality of network nodes. In some implementations, the plurality of network nodes can be configured to receive multicast messages, transmit multicast messages, or both receive and transmit multicast messages.

The procedure 700 continues to step 715 where, as described above, the controller identifies a first subset of the plurality of network nodes that are candidates for network node replication (e.g., those with more than two connected nodes, those with branches, or those otherwise configured to replicate multicast traffic). That is, in one implementation, identifying the first subset of the plurality of network nodes that are candidates for network node replication is based on the first subset having more than two connected neighbor nodes (physically and/or as configured in a multicast tree). In some implementations, the first subset of the plurality of network nodes can comprise provider edge nodes. Implementations are not so limited, however, and other types of network nodes and devices are contemplated within the scope of the disclosure.

The procedure 700 continues to step 720 where, as described above, the controller identifies a second subset of the plurality of network nodes that are not candidates for network node replication (e.g., those with only two connected nodes, those without branches, or those not configured to replicate multicast traffic). That is, in one Implementation, identifying the second subset of the plurality of network nodes that are not candidates for network node replication is based on the second subset having not more than two connected neighbor nodes (physically and/or as configured in a multicast tree).

The procedure 700 continues to step 725 where, as described above, the controller initiates one or more path computation element protocol sessions based, at least in part, on identification of the first subset of the plurality of network nodes and the second subset of the plurality of network nodes. As discussed above, in some implementations, the procedure 700 can include initiating, by the controller, the one or more path computation element protocol sessions automatically subsequent to analyzing the plurality of network nodes. In addition to, or in the alternative, in some implementations, the procedure 700 can include initiating, by the controller, the one or more path computation element protocol sessions in response to a user command.

In some implementations, the procedure 700 can further include determining, by the controller, one or more permanent transmission control protocol connections to establish based on the first subset of the plurality of network nodes that are candidates for network node replication and establishing, by the controller, SR-PCE, etc. the one or more permanent transmission control protocol connections.

In such implementations, the procedure 700 can further include establishing the one or more permanent transmission control protocol connections when a quantity of devices in a network that includes the plurality of network nodes meets a particular threshold. That is, when a particular number of devices (e.g., nodes) have been determined to meet conditions to be replicator nodes, the controller can establish permanent transmission control protocol connections to such nodes. Further, in such implementations, the procedure 700 can include refraining from establishing any permanent transmission control protocol connections involving the second subset of the plurality of network nodes that are not candidates for network node replication.

In some implementations, the procedure 700 can further include monitoring, by the controller, the plurality of network nodes to determine changes in a topology of a network in which the plurality of network nodes are deployed; determining that a particular node among the first subset of the plurality of network nodes is no longer a candidate for network node replication; and updating, by the controller, the one or more path computation element protocol sessions based, at least in part, on determining that the particular node among the first subset of the plurality of network nodes is no longer a candidate for network node replication.

In some implementations, the procedure 700 can further include monitoring, by the controller, the plurality of network nodes to determine changes in a topology of a network in which the plurality of network nodes are deployed; determining that a particular node among the second subset of the plurality of network nodes has become a candidate for network node replication; and updating, by the controller, the one or more path computation element protocol sessions based, at least in part, on determining that the particular node among the second subset of the plurality of network nodes has become a candidate for network node replication.

Procedure 700 may end at step 730.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: analyzing a plurality of network nodes to determine replication characteristics associated with the plurality of network nodes; identifying a first subset of the plurality of network nodes that are candidates for network node replication; identifying a second subset of the plurality of network nodes that are not candidates for network node replication; and initiating one or more path computation element protocol sessions based, at least in part, on identification of the first subset of the plurality of network nodes and the second subset of the plurality of network nodes.

In still other implementations, a tangible, non-transitory, computer-readable medium storing program instructions that cause a device to execute a process comprising: monitoring, by the controller, the plurality of network nodes to determine changes in a topology of a network in which the plurality of network nodes are deployed; determining that a particular node among the second subset of the plurality of network nodes has become a candidate for network node replication; and updating, by the controller, the one or more path computation element protocol sessions based, at least in part, on determining that the particular node among the second subset of the plurality of network nodes has become a candidate for network node replication.

The techniques described herein, therefore, provide for controller driven multicast for scalability. As discussed above, implementations described herein provide a framework where a controller (e.g., an SDN controller, SR-PCE, etc.) can make PCEP connections and/or (permanent) TCP connections only using limited number of devices in network. For example, by determining nodes that are candidates for replication and nodes that are not candidates for replication, implementations described herein can reduce the overall number of PCEP sessions required to provide robust network solutions.

As discussed above, such features can allow for improved controller-driven multicast deployment scaling, reduction in resources used in the network, particularly during network configuration, and/or can reduce the amount of time a network administrator or user spends trying to configure the network. These and other advantages described herein can allow for improved scalability in networks that employ not only multicast paradigms, but also unicast paradigms, thereby affording scalability into the hundreds of thousands of device range, in contrast to current approaches.

Illustratively, the techniques described herein may be performed by hardware, software, and/or firmware, (e.g., an “apparatus”) such as in accordance with the multicast process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
analyzing, by a controller, a plurality of network nodes to determine replication characteristics associated with the plurality of network nodes;
identifying, by the controller, a first subset of the plurality of network nodes that are candidates for network node replication;
identifying, by the controller, a second subset of the plurality of network nodes that are not candidates for network node replication; and
initiating, by the controller, one or more path computation element protocol sessions based, at least in part, on identification of the first subset of the plurality of network nodes and the second subset of the plurality of network nodes.

2. The method of claim 1, wherein identifying the first subset of the plurality of network nodes that are candidates for network node replication is based on the first subset having more than two connected neighbor nodes, and wherein identifying the second subset of the plurality of network nodes that are not candidates for network node replication is based on the second subset having not more than two connected neighbor nodes.

3. The method of claim 1, further comprising:
determining, by the controller, one or more permanent transmission control protocol connections to establish based on the first subset of the plurality of network nodes that are candidates for network node replication; and
establishing, by the controller, the one or more permanent transmission control protocol connections.

4. The method of claim 3, further comprising:
establishing the one or more permanent transmission control protocol connections when a quantity of devices in a network that includes the plurality of network nodes meets a particular threshold.

5. The method of claim 1, further comprising:
refraining from establishing any permanent transmission control protocol connections involving the second subset of the plurality of network nodes that are not candidates for network node replication.

6. The method of claim 1, further comprising:
initiating, by the controller, the one or more path computation element protocol sessions automatically subsequent to analyzing the plurality of network nodes.

7. The method of claim 1, further comprising:
initiating, by the controller, the one or more path computation element protocol sessions in response to a user command.

8. The method of claim 1, wherein the plurality of network nodes are configured to receive multicast messages, transmit multicast messages, or both receive and transmit multicast messages.

9. The method of claim 1, further comprising:
monitoring, by the controller, the plurality of network nodes to determine changes in a topology of a network in which the plurality of network nodes are deployed;
determining that a particular node among the first subset of the plurality of network nodes is no longer a candidate for network node replication; and
updating, by the controller, the one or more path computation element protocol sessions based, at least in part, on determining that the particular node among the first subset of the plurality of network nodes is no longer a candidate for network node replication.

10. The method of claim 1, further comprising:
monitoring, by the controller, the plurality of network nodes to determine changes in a topology of a network in which the plurality of network nodes are deployed;
determining that a particular node among the second subset of the plurality of network nodes has become a candidate for network node replication; and
updating, by the controller, the one or more path computation element protocol sessions based, at least in part, on determining that the particular node among the second subset of the plurality of network nodes has become a candidate for network node replication.

11. An apparatus, comprising:
one or more network interfaces to communicate with a network;
a processor coupled to the one or more network interfaces and configured to execute one or more processes; and
a memory configured to store a process that is executable by the processor, the process comprising:
analyzing a plurality of network nodes to determine replication characteristics associated with the plurality of network nodes;
identifying a first subset of the plurality of network nodes that are candidates for network node replication;
identifying a second subset of the plurality of network nodes that are not candidates for network node replication; and
initiating one or more path computation element protocol sessions based, at least in part, on identification of the first subset of the plurality of network nodes and the second subset of the plurality of network nodes.

12. The apparatus of claim 11, wherein the process further comprises:
determining one or more permanent transmission control protocol connections to establish based on the first subset of the plurality of network nodes that are candidates for network node replication; and
establishing the one or more permanent transmission control protocol connections.

13. The apparatus of claim 12, wherein the process further comprises:
establishing the one or more permanent transmission control protocol connections when a quantity of devices in a network that includes the plurality of network nodes meets a particular threshold.

14. The apparatus of claim 11, wherein the process further comprises:
refraining from establishing any permanent transmission control protocol connections involving the second subset of the plurality of network nodes that are not candidates for network node replication.

15. The apparatus of claim 11, wherein the process further comprises:
initiating the one or more path computation element protocol sessions automatically subsequent to analyzing the plurality of network nodes.

16. The apparatus of claim 11, wherein the process further comprises:
initiating the one or more path computation element protocol sessions in response to a user command.

17. The apparatus of claim 11, wherein the plurality of network nodes are configured to receive multicast messages, transmit multicast messages, or both receive and transmit multicast messages.

18. The apparatus of claim 11, wherein the process further comprises:
monitoring the plurality of network nodes to determine changes in a topology of a network in which the plurality of network nodes are deployed;
determining that a particular node among the first subset of the plurality of network nodes is no longer a candidate for network node replication; and
updating the one or more path computation element protocol sessions based, at least in part, on determining that the particular node among the first subset of the plurality of network nodes is no longer a candidate for network node replication.

19. The apparatus of claim 11, wherein the process further comprises:
monitoring the plurality of network nodes to determine changes in a topology of a network in which the plurality of network nodes are deployed;
determining that a particular node among the second subset of the plurality of network nodes has become a candidate for network node replication; and
updating the one or more path computation element protocol sessions based, at least in part, on determining that the particular node among the second subset of the plurality of network nodes has become a candidate for network node replication.

20. A tangible, non-transitory, computer-readable medium storing program instructions that cause a device to execute a process comprising:
analyzing, by a controller, a plurality of network nodes to determine replication characteristics associated with the plurality of network nodes;
identifying, by the controller, a first subset of the plurality of network nodes that are candidates for network node replication;
identifying, by the controller, a second subset of the plurality of network nodes that are not candidates for network node replication; and
initiating, by the controller, one or more path computation element protocol sessions based, at least in part, on identification of the first subset of the plurality of network nodes and the second subset of the plurality of network nodes.
